(19) United States
(12) Patent Application Publication
(10) Pub. No.: US 2005/0074528 A1
(43) Pub. Date: Apr. 7, 2005

(54) Packaging comprising a container and membrane

(76) Inventors: Jean Servaux, La Tour-de-Peliz (CH); Chantal Servaux, La Tour-de-Peliz (CH)

Correspondence Address: WINSTON & STRAWN;PATENT DEPARTMENT, 1400 L STREET, N.W., WASHINGTON, DC, 20005-3502, US

(21) Appl. No.: 10/784,034

(22) Filed: Feb. 20, 2004

Related U.S. Application Data
(63) Continuation of application No. 10/448,340, filed on May 30, 2003, now abandoned.
Application No. 10/448,340 is a continuation-in-part of application No. PCT/EP01/14186, filed on Nov. 28, 2001.

(30) Foreign Application Priority Data
Dec. 1, 2000 (EP) 00126269.0

(51) Int. Cl. C12C 1/027

(52) U.S. Cl. 426/106

(57) ABSTRACT

The present invention relates to packaging of a container having a neck and a body. The neck has a rim and a membrane sealed around its periphery. The rim includes at least one zone to allow sufficient grasp of the membrane for easy removal of the membrane from the rim during opening of the packaging.

### CROSS-REFERENCE TO RELATED APPLICATIONS

This application is a continuation of U.S. application Ser. No. 10/448,340 filed May 30, 2003, and a ontinuation-in-part of International Application PCT/EP01/14186 filed Nov. 28, 2001. The content of each prior application is expressly incorporated herein by reference thereto.

### BACKGROUND OF THE INVENTION

Packaging currently known on the market comprises a jar with a rim, a closure means and a membrane bonded onto the periphery of the rim. This type of packaging is more particularly used for packaging soluble coffee, but can also be used for any packaging of powdered products. In order to open the jar with this type of packaging, the membrane has to be torn, and this may cause problems regarding the possibility of getting bits of membrane into the product in the jar.

At the present time, instead of bonding the membrane onto the rim of the jar, an alternative is induction sealing the membrane to the jar. This technique consists of filling the jar with the product concerned, bringing the closure means in which the membrane is located, onto the filled jar and sealing the membrane by induction. The major benefit of this technique is that when the jar is opened for the first time, it is possible for the membrane to be peeled off. However, in order to peel off the membrane, a part for grasping is needed. Normally, this is a tab which protrudes from the periphery of the rim of the jar. As the tab is only a small extension of the sealed membrane, it can be torn away from the membrane thus making it more difficult to remove the membrane.

It would be advantageous to have a peel-off solution without the use of a tab. Such a solution is already known in the U.S. Pat. Nos. 3,857,506 and 3,632,004. The drawback of these solutions is that they do not allow a good grasp of the membrane, and often the membrane is not totally peeled off, or the membrane is torn during peeling.

Thus, a need exits for a container with an induction-sealed membrane or another type of sealing, in which the consumer can easily peel off the membrane without the presence of a tab and wherein there is a guarantee that the membrane does not tear during the peel-off. The present invention now satisfies this need.

### SUMMARY OF THE INVENTION

The invention relates to a packaging comprising a container having a neck and a body, the neck having a rim, and a membrane sealed around the periphery of the rim. The rim comprises at least one zone to allow sufficient grasp of the membrane for removal of the membrane from the rim during opening of the packaging. Advantageously, the membrane has a uniform periphery and at least one zone of the rim is provided by configuring the rim to have a periphery that is non-uniform with respect to the membrane and that is provided within the periphery of the membrane.

Preferably, the membrane has a polygonal, elliptical, oval or circular periphery and the at least one zone of the rim provides an exposed area of the membrane to allow sufficient grasp of the membrane for removal of the membrane from the rim during opening of the packaging. In another embodiment, the at least one zone comprises at least one flat surface associated with the rim, wherein the flat surface allows at least a portion of the membrane to protrude beyond the flat surface to provide the exposed area for grasping. In another embodiment, the rim includes at least one zone having a reduced thickness over a distance, and further wherein the reduced thickness of the rim allows protrusion of at least a portion of the membrane to provide the exposed area for grasping.

### BRIEF DESCRIPTION OF THE DRAWINGS

FIG. 1 depicts a perspective view of the packaging according to the first embodiment,

FIG. 2 is a perspective view of the packaging according to a second embodiment,

FIG. 3 is a view from above of the rim of the embodiment of FIG. 2,

FIG. 4 is a part section of the packaging according to the invention in the third embodiment, and

FIG. 5 is a view from above of the rim of the jar.

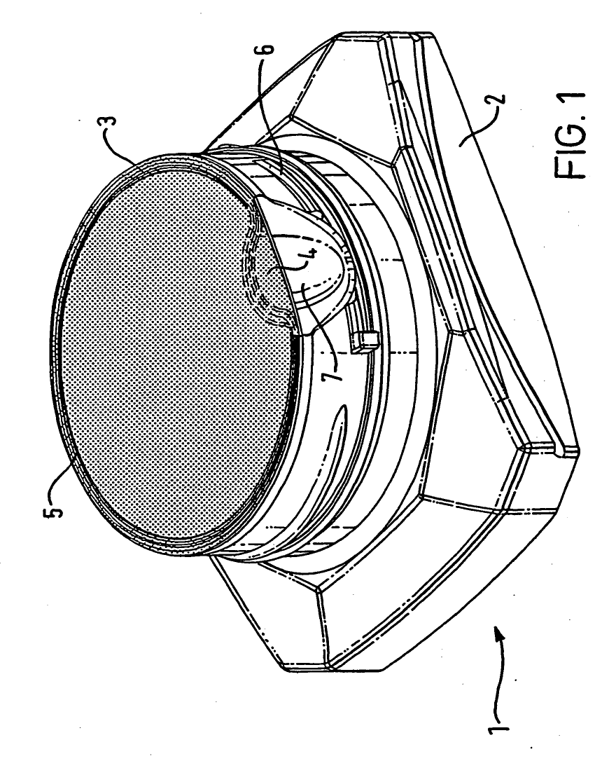

### DETAILED DESCRIPTION OF THE PREFERRED EMBODIMENTS

The present invention provides a container with a sealed membrane, which is easily peeled off and which is resistant to tearing during removal. The invention relates to a packaging comprising a container with a neck or a flange and a body, wherein the neck has a rim and a substantially circular or elliptical membrane sealed around the entire periphery of the rim or of the flange. The packaging is designed such that the rim of the neck or the flange has one or more particular zones over part of its periphery, so as to allow a good grasp of the membrane so that it can be easily peeled-off or removed from the rim or flange.

In accordance with the invention, the container can be a cup or a tray with a flange on which the membrane is sealed. However, any type of container is suitable. For example, the container may comprise a jar with a neck and a body, with neck comprising an external screw thread or bosses and a rim, as well as closure means which can be screwed or snap-fastened over the external screw thread or the bosses of the neck of the jar.

Closuring means such as by screwing or snap-fastening are known in the art and therefore will not be explained further in the present description. In the case of screw-fastening, there is a screw thread on the neck of the jar and, in the case of snap-fastening, there are bosses on the neck. The closure means in both instances comprise catching means collaborating with the screw thread or the bosses of the neck of the jar.

It is to be clearly understood that the packaging contains any type of food or food-forming product, and preferably one that is in the form of powder, or paste, or granules or liquid. This may, with equal preference, be a food product or a cosmetic product or any other type of product that can be packaged in a container with a membrane. For example, the invention preferably envisages the packaging of soluble coffee in a jar, of yogurts or pet food in the case that the container is a cup or a tray. The cup can be a thermoformed plastic or an aluminum tray.

The term “jar” is to be understood in the present description as meaning a container for holding a volume of the product. The container may be of roughly square or circular cross section or of any other geometry with a matching or different neck. Generally, the neck is roughly circular or elliptical and the closure means is screwed or snap-fastened onto it. The closure means is a lid of circular, elliptical or polygonal shape, such as a hexagonal or octagonal shape.

The jar can equally well be made of glass, plastic, aluminum or a composite/multilayers. The term “plastic” is to be understood as meaning a plastic that can be employed in the food area, for example polyethylene, polypropylene or polystyrene. In the case of glass, it is possible to have either a bottle or a cup for yogurts or others. The lid is made of plastic. This lid is preferably made of polyethylene or polypropylene.

According to a first embodiment of the packaging according to the invention, the rim of the neck or the flange has at least one particular zone which comprises at least one area or re-entrant part of appropriate size to allow grasping of the membrane by the thumb and finger of a person. This re-entrant part has preferentially the form of an arc of circle, which corresponds to the ergonomics of the thumb or a finger. There is thus a small niche into which a thumb or finger can be slipped or received in so that the thumb or finger can grasp the membrane to pull on it with a regular and constant force at the time of opening. The dimensions of this re-entrant part are preferably a width of about 1-2 cm and a depth of about 5 mm. In this embodiment, the rim has the same thickness around the entire periphery of the jar.

The membrane used according to the invention is not critical. It may be of any type, namely of aluminum or a multi-layer with a sealable layer or the like allowing good sealing when it passes under the induction sealing head. It is also possible to have a membrane with a paper layer and a sealing layer. The paper and aluminum have an oxygen barrier functionality. The membrane can be sealed to the rim by conduction, by induction, by sticking or ultrasound.

In a second embodiment of the packaging according to the invention, the rim of the neck or the flange has at least one particular zone in which the rim or the flange has at least one flat, sized such that it allows the membrane to protrude. The flat is designed in such a way that the membrane protrudes by about 4 to 6 mm. If consideration is given to the roughly circular neck of the jar and the center of symmetry of the said jar, it is possible to envision a flat having an angle of between 10 and 45° with the center of the jar. As a preference, the angle subtended is of the order of 20-30°. Quite obviously, in this embodiment, the rim has the same thickness around the entire periphery.

In a third embodiment of the packaging according to the invention, the rim of the neck has at least one or two particular zones, for which the thickness of the rim is less over a distance such that it allows the membrane to protrude. The difference with respect to the previous solution is that in this case there is no flat, that is to say that the rim is circular around the entire periphery, but it is the thickness of the rim which is less over a certain distance. This distance with the zone of lesser thickness is of the order of 1 to 2 cm and allows the membrane to protrude by 1-3 mm. It is preferable to have two diametrically opposed zones, but it is also possible to have more zones. The remainder of the description is given with reference to the drawings with screw-closure means, in which drawings:

The glass jar (1) comprises a body (2) and a neck (3). A membrane (4) is sealed onto the rim (5) of the neck. The screw thread (6) onto which the closure means (not depicted) will be screwed can be clearly seen. In this embodiment, the neck (3) has a re-entrant part (7). The rim has the same thickness and a diameter that is generally of between about 4 and 7 cm. Thus, the membrane has a circumference (2πr) of about 12 to 22 cm. The re-entrant part has a width of 15 mm and a depth of 5 mm. At the time of use, the consumer removes the closure means and flips his finger under the re-entrant part (7) to lift the membrane (4): the product can be consumed and the closure means then has merely to be replaced.

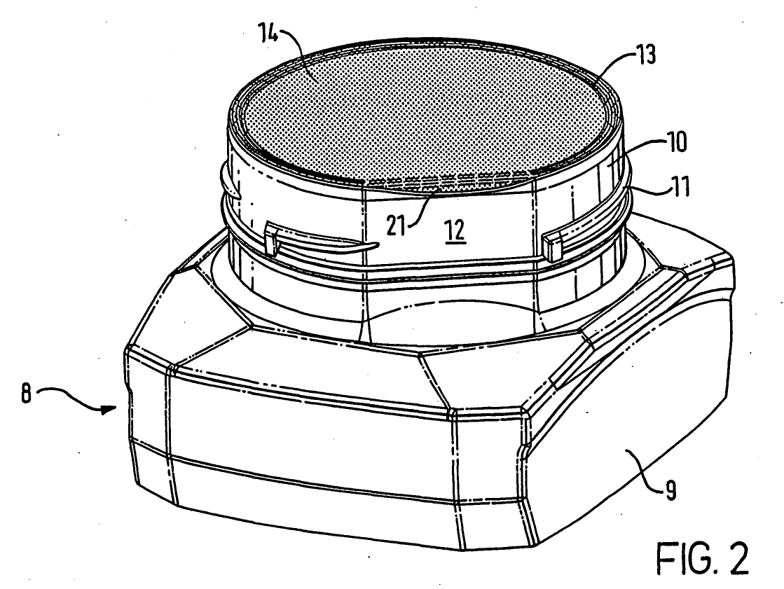

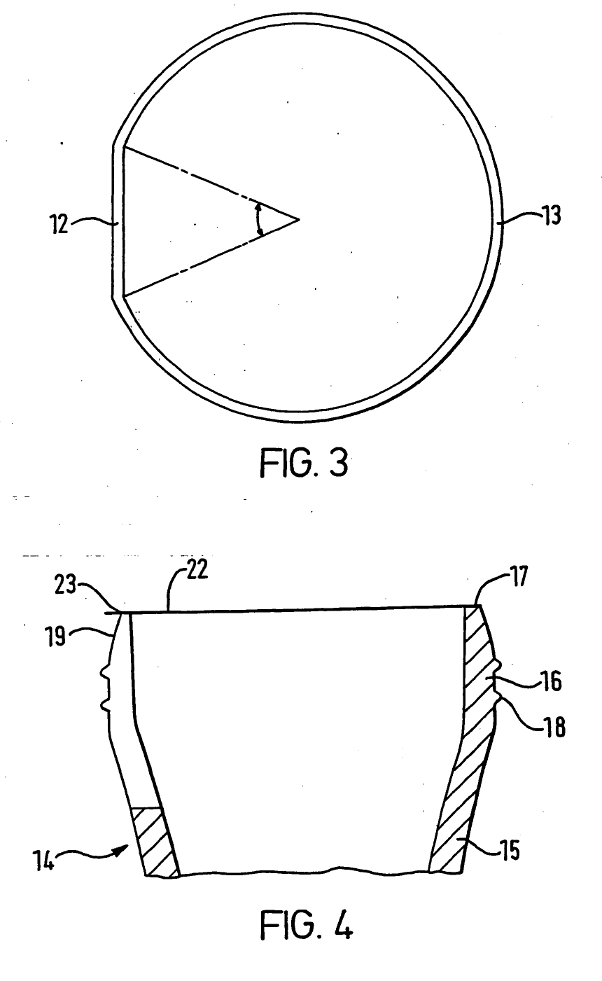

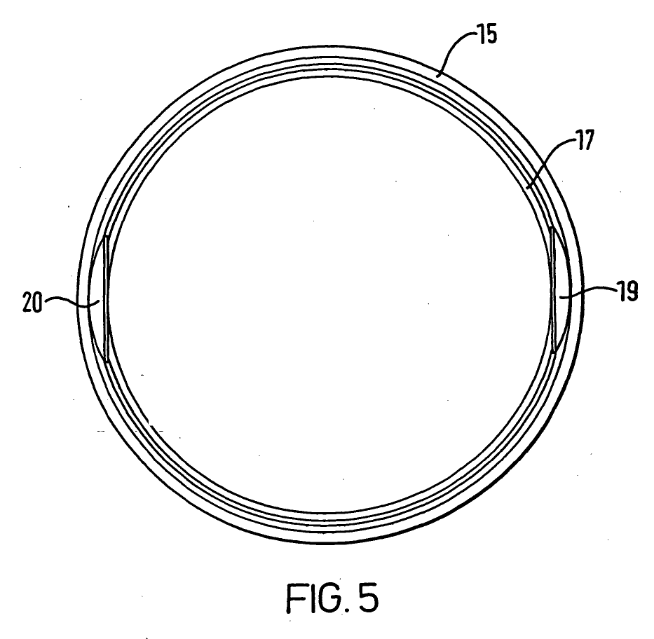

In the embodiment of FIG. 2, the jar (8) comprises a body (9) and a neck (10). A membrane (14) is sealed to the rim (13) of the jar. The screw thread (11) of the jar allows the closure means (not depicted) to be screwed on. According to this second embodiment, the rim of the jar has a flat (12), so that the membrane protrudes at (21) to allow, at the time of use, the said membrane to be grasped easily. FIG. 3 specifies that in this embodiment, the angle ox subtended at the center is 30°. In this case, the distance by which the membrane protrudes is 5 mm.

The last two figures give a third embodiment, in which the jar (14) has a body (15) and a neck (16). The screw thread (18) on the jar allows the closure means (not depicted) to be screwed on. The rim (17) has a constant thickness, except in the two zones (19, 20) in which it has a smaller thickness, so that the circular membrane (22) protrudes at (23) from these two zones, thus allowing the user to grasp the membrane easily when he wishes to peel it off. In the example in this figure, the rim has a thickness of 3 mm and, in the zones (19, 20) has a thickness of 1.5 mm, the membrane thus protruding by 1.5 mm on each side.

The present invention makes it possible to provide the consumer with packaging with an induction-sealed membrane, in which there are good solutions for grasping hold of the said membrane, without having a tab.

1. A packaging comprising:
a container having a neck and a body, the neck having a rim, and
a membrane sealed around the periphery of the rim, wherein the rim comprises at least one zone to allow sufficient grasp of the membrane for removal of the membrane from the rim during opening of the packaging.

2. The packaging according to claim 1, wherein the membrane has a uniform periphery and at least one zone of the rim is provided by configuring the rim to have a periphery that is non-uniform with respect to the membrane and that is provided within the periphery of the membrane.

3. The packaging according to claim 2 wherein the membrane has a polygonal, elliptical, oval or circular periphery and the at least one zone of the rim provides an exposed area of the membrane to allow sufficient grasp of the membrane for removal of the membrane from the rim during opening of the packaging.

4. The packaging according to claim 3, wherein the at least one zone comprises at least one flat surface associated with the rim, wherein the flat surface allows at least a portion of the membrane to protrude beyond the flat surface to provide the exposed area for grasping.

5. The packaging according to claim 3, wherein the rim includes at least one zone having a reduced thickness over a distance, and further wherein the reduced thickness of the rim allows protrusion of at least a portion of the membrane to provide the exposed area for grasping.

6. The packaging according to claim 3, wherein the exposed area has a width of about 1-2 cm and a depth of about 5 mm relative to a membrane having a periphery of about 12 to 22 cm.

7. The packaging according to claim 3, wherein the exposed area comprises a niche corresponding to the ergonomics of a finger or thumb.

8. The packaging according to claim 4, wherein the flat forms an angle of about 10° and 45° with the center of symmetry of the container.

9. The packaging according to claim 8, wherein the membrane protrudes from the periphery of the rim by about 4-6 mm.

10. The packaging according to claim 5, wherein the rim includes at least one zone of lesser thickness having a length of 1-2 cm.

11. The packaging according to claim 10, wherein the membrane protrudes from the periphery of the rim by about 1-3 mm.

12. The packaging according to claim 5, wherein the rim comprises diametrically opposing zones of lesser thickness.

13. The packaging according to claim 1, wherein the membrane is substantially circular or substantially elliptical in shape.

14. The packaging according to claim 1, wherein the container is a cup, tray or jar.

15. The packaging according to claim 1, wherein the neck comprises screw thread or bosses, and wherein the packaging further includes closure means configured to be screwed or snap-fastened to the screw thread or bosses of the neck to close the package.

16. The packaging according to claim 1, wherein the jar is made of glass, plastic or aluminum.

17. The packaging according to claim 1, wherein the membrane comprises aluminum, plastic or paper.

18. The packaging according to claim 17, wherein the paper, plastic or the aluminum function as an oxygen barrier during sealing of the membrane to the container.

19. The packaging according to claim 1, wherein the membrane is sealed to the rim of the container by a conduction, induction, sticking or ultrasound process.

20. The packaging according to claim 1 which includes a food or food-forming ingredient therein.
